(19) United States
(12) Patent Application Publication
(10) Pub. No.: US 2015/0277903 A1
(43) Pub. Date: Oct. 1, 2015

(54) Method for Checking for the Presence of a Current Firmware Version

(71) Applicant: Endress + Hauser Conducta Gesellschaft für Mess-und Regeltechnik mbH + Co. KG, Gerlingen (DE)

(72) Inventor: Dietrich Wentland, Stuttgart (DE)

(21) Appl. No.: 14/669,308

(22) Filed: Mar. 26, 2015

(30) Foreign Application Priority Data
Mar. 27, 2014 (DE) 10 2014 104 305.7

(51) Int. Cl. G06F 9/44

(52) U.S. Cl. CPC G06F 8/71

(57) ABSTRACT

A method for checking for the presence of a current firmware version of a sensor by a measurement transmitter, wherein in the measurement transmitter a table is stored, the table contains at least one firmware version number and associated information concerning the presence of a current firmware version. The method comprises the steps of: connecting the sensor to the measurement transmitter; ascertaining a firmware version number of the sensor by the measurement transmitter; comparing the firmware version number of the sensor with the at least one firmware version number in the table; ascertaining the information concerning the presence of a current firmware version based on the at least one firmware version number in the table; and producing a report, which displays the information concerning the presence of a current firmware version.

The invention relates to a method for checking for the presence of a current firmware version of a sensor by a measurement transmitter.

Modern sensors usually comprise hardware having a hardware version number and firmware having a firmware version number. Provided from time to time for new sensors is a current firmware version, which is more recent than the firmware version of the sensor. If a current firmware version is provided for a sensor, the current firmware version can be stored in the sensor and then installed. For older sensors, no current firmware version is provided.

Sensors are connected in measurement operation with a measurement transmitter. A sensor with an unknown, respectively incorrect, firmware- or hardware version cannot be operated connected to a measurement transmitter. A failure report is issued.

A user of the sensor does not necessarily know that a current firmware version is available for the sensor. The sensor continues to be operated with the old firmware version, even though a new firmware version is available. The user of the sensor must study the latest information and so acquire knowledge concerning the existence of new firmware for the sensor.

An object of the invention is to provide a method, which automatically informs users concerning the existence of a new firmware version of a sensor.

The object is achieved according to the invention by the subject matter of claim 1. The subject matter of claim 1 is a method for checking for the presence of a current firmware version of a sensor by a measurement transmitter, wherein in the measurement transmitter a table is stored, which contains at least one firmware version number and associated information concerning the presence of a current firmware version, comprising steps as follows: connecting the sensor to the measurement transmitter, ascertaining a firmware version number of the sensor by the measurement transmitter, comparing the firmware version number of the sensor with the at least one firmware version number in the table, ascertaining the information concerning the presence of a current firmware version based on the at least one firmware version number in the table, producing a report, which displays the information concerning the presence of a current firmware version.

The report informs the user concerning which firmware version is installed in the sensor and whether a current firmware version is available.

In an advantageous form of embodiment, the table is updated via an interface, especially via an SD card or via Ethernet. The table can be automatically updated by the measurement transmitter or manually by the user.

In an advantageous further development, the table provides information for a certain firmware version number as follows:
No current firmware version of the sensor exists,
Current firmware version is available,
Firmware version of the sensor is the current firmware version. In the case of older firmware versions with corresponding older firmware version numbers, the first item of information is displayed in the report. These sensors are sufficiently old that a current firmware version is no longer available. The second item of information relates to sensors for which a current firmware version is available. The third item of information is for new sensors with new firmware version. In the case of these sensors, the installed firmware version is already the most up-to-date firmware version. A current firmware version is not provided.

In an advantageous variant, the report contains at least three options for the user, wherein a first option includes the performing of the updating of the firmware version, wherein a second option includes time shifting of the producing of the report, and wherein a third option includes ignoring the report contains. The user thus has the options of updating now or later or even not performing the updating. The later performing of the updating is a good choice, for example, when the sensor is in measurement operation or is in the process of recording measurement data.

In an advantageous embodiment, the performing of the updating of the firmware occurs manually or automatically. If the user decides to install the current firmware version, such can be done either manually or automatically. In the case of a manual installation, first the firmware with the current firmware version is copied by user to the sensor and stored and then the installation executed.

In an advantageous further development, the sensor includes hardware with a hardware version, wherein the at least one firmware version number is associated in the table with a hardware version number, wherein the measurement transmitter ascertains a hardware version number of the sensor and compares such with the hardware version number in the table and references the comparison for ascertaining information concerning the presence of a current firmware version. Besides the firmware version, also the hardware version can be taken into consideration for checking for the presence of the current firmware version of the sensor. In this regard, the table includes for each firmware version number a hardware version number, which is likewise linked with associated information concerning the presence of a current firmware version.

The invention will now be explained in greater detail based on the appended drawing, the figures of which show as follows:

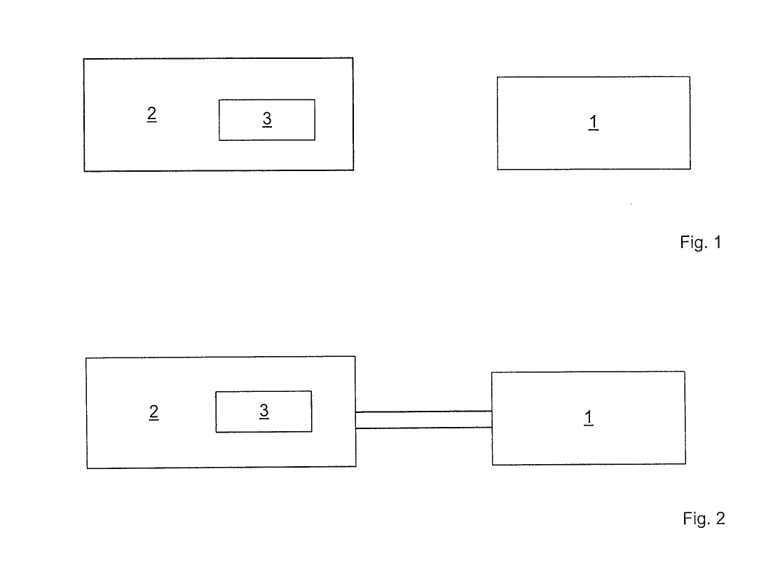

FIG. 1 a schematic drawing of a sensor and a measurement transmitter, and

FIG. 2 a schematic view of a sensor connected to the measurement transmitter.

FIG. 1 shows a schematic drawing of a sensor 1 and a measurement transmitter 2. The measurement transmitter 2 includes a table 3 as follows:

| hardware version | firmware version | |
|---|---|---|
| number | number | information |
| 10.0 | 11.0 | not updatable |
| 20.0 | 21.0 | updatable |
| 20.1 | 21.4 | current |

The table 3 has three columns and four rows. The first column lists three hardware version numbers 10.0, 20.0 and 20.1. The second column lists three firmware version numbers 11.0, 21.0 and 21.4. The third column lists three items of information concerning the presence of a current firmware version. The three items of information comprise, respectively, “not updatable”, “updatable” and “current”. The item of information, “not updatable”, means that no current firmware version exists for the sensor 1. The item of information, “updatable”, means that a current firmware version exists for the sensor 1. The item of information, “current”, means that the firmware version of the sensor 1 is already current. In accordance with common practice, the hardware version number, firmware version number and information of a row of the table 3 are associated with one another. Table 3 is updated via an interface, such as, for example, an SD card or Ethernet interface.

FIG. 2 shows a schematic view of a sensor 1 connected to the measurement transmitter 2. Only then can the method of the invention be performed. The method of the invention includes method steps as follows: First, the measurement transmitter 2 ascertains the firmware version number of the sensor 1. Then the measurement transmitter 2 compares the firmware version number of the sensor 1 with the firmware version number in the table 3. If the comparison ascertains an agreement, the firmware version number and the associated information from table 3 are displayed to the user as a report.

If, for example, the measurement transmitter 2 ascertains a firmware version of the sensor with the firmware version number 11.0, the associated information “not updatable” is ascertained from the table 3 and the measurement transmitter produces the report “No current firmware version of the sensor exists.” If, for example, a firmware version number 21.0 of the sensor 1 is ascertained, the associated information “updatable” in the table 3 results and the measurement transmitter produces the report “Current firmware version is available.” If the measurement transmitter 2 ascertains, however, a firmware version number 21.4 of the sensor 1, then the measurement transmitter 2 ascertains the information “current” from the table 3 and produces the report “Firmware version of the sensor is the current firmware version.”

Furthermore, the sensor 1 includes hardware with a hardware version number. In addition to the firmware version number, the measurement transmitter 2 can refer to the hardware version number of the sensor 1 for ascertaining the information concerning the presence of a current firmware version. The associating of the hardware version number with the information concerning the presence of a current firmware version occurs analogously to the associating of the firmware version number (see the table 3).

Furthermore, the report contains besides the firmware version number of the sensor and the information concerning the presence of a current firmware version, three options, which the user can follow. A first option enables the user to perform the updating of the firmware immediately. A second option enables producing the report at a later point in time. In such case, the user decides when the later point in time should be. A third option enables ignoring the report. The report is then not redisplayed. A report is subsequently reproduced only when a current firmware version is available.

### LIST OF REFERENCE CHARACTERS

1 sensor
2 measurement transmitter
3 table

1-6. (canceled)

7. A method for checking for the presence of a current firmware version of a sensor by a measurement transmitter, wherein in the measurement transmitter a table is stored, which contains at least one firmware version number and associated information concerning the presence of a current firmware version, the method comprising the steps of:
connecting the sensor to the measurement transmitter;
ascertaining a firmware version number of the sensor by the measurement transmitter;
comparing the firmware version number of the sensor with the at least one firmware version number in the table;
ascertaining the information concerning the presence of a current firmware version based on the at least one firmware version number in the table; and
producing a report, which displays the information concerning the presence of a current firmware version.

8. The method as claimed in claim 7, wherein:
the table is updated via an interface.

9. The method as claimed in claim 7, wherein:
the table provides information for a certain firmware version number as follows:
no current firmware version of the sensor exists,
current firmware version is available,
firmware version of the sensor is the current firmware version.

10. The method as claimed in claim 7, wherein:
the report contains at least three options for the user, a first option includes the performing of the updating of the firmware, a second option includes time shifting of the producing of the report, and a third option includes ignoring the report.

11. The method as claimed in claim 10, wherein:
the performing of the updating of the firmware occurs manually or automatically.

12. The method as claimed in claim 7, wherein:
the sensor includes hardware with a hardware version, the at least one firmware version number is associated in the table with a hardware version number;
the measurement transmitter ascertains a hardware version number of the sensor and compares such with the hardware version number in the table and references the comparison for ascertaining information concerning the presence of a current firmware version.

13. The method as claimed in claim 8, wherein:
the interface confirms an SD card.

14. The method as claimed in claim 8, wherein:
the interface comprises Ethernet.
